(19) United States
(12) Patent Application Publication
(10) Pub. No.: US 2018/0033007 A1
(43) Pub. Date: Feb. 1, 2018

(54) MOBILE SECURED PAYMENT METHOD AND SYSTEM

(71) Applicant: GM GLOBAL TECHNOLOGY OPERATIONS LLC, Detroit, MI (US)

(72) Inventors: Eric Chen, Shanghai (CN); Peggy Wang, Shanghai (CN); Xiaowen Dai, Shelby township, MI (US)

(73) Assignee: GM GLOBAL TECHNOLOGY OPERATIONS LLC, Detroit, MI (US)

(21) Appl. No.: 15/549,404

(22) PCT Filed: Feb. 9, 2015
(86) PCT No.: PCT/CN2015/072530

§ 371 Date: Aug. 8, 2017

(51) Int. Cl. G06Q 20/40; G06Q 30/02; G06Q 20/32

(52) U.S. Cl. CPC G06Q 20/4014; G06Q 20/32; G06Q 30/0267

(57) ABSTRACT

A system and method are disclosed for making secure, mobile financial transactions, for example, for the purchase of and payment for travel-centric goods/services. The mobile transaction is initiated by placing an on-the-go order for an item with a merchant at a location remote from the purchaser. A payment from a registered payor account is authorized by entering the payment password on a purchaser interface for validating the payment. A purchaser identifier is presented to the merchant for verifying the transaction, and delivery of the item from the merchant is accepted by the purchaser.

### TECHNICAL FIELD

The technical field generally relates to methods and systems for making an e-commerce transaction, and more particularly to methods and systems for completing a mobile transaction including secured payment for the transaction.

### BACKGROUND

Consumers today are becoming more accustomed to making purchases and payments using electronic commerce (“e-commerce”). Even mobile e-commerce on smart phones and tablets has become familiar to consumers. Most of these transactions relate to on-line purchases of consumer goods, and are not linked to the purchaser's environment or centric to the purchaser's activities. Except for single-purpose payment systems, such as an electronic toll collection, conventional mobile commerce applications are not specifically adapted for mobile purchases of goods or services which allow independent validation and verification for payment.

Accordingly, it is desirable to provide a multi-purposed method and system for completing a mobile transaction including secured payment for the transaction. In addition, other desirable features and characteristics of the present disclosure will become apparent from the subsequent detailed description and the appended claims, taken in conjunction with the accompanying drawings and the foregoing technical field and background.

### SUMMARY

Methods and systems are provided for managing a user profile for mobile transactions. In one embodiment, a method for making an on-the-go transaction payment is provided. A payor account having payor account data including a user ID, a payment password, a payment method and a purchaser identifier is registered to enable a mobile transaction. The mobile transaction is initiating by placing an on-the-go order (such as from a vehicle) for an item with a merchant at a location remote from the purchaser. A payment from the payor account is authorized by entering the payment password on a purchaser interface deployed for validating the payment. The purchaser identifier is presented to the merchant at the remote location for verifying the transaction, completing a secured payment and delivering the item from the merchant when accepted by the purchaser.

In one embodiment, a method for making a secured transaction payment is provided. A payor account is registered on a remote transaction module. The payor account includes payor account data such as a user ID, a payment password, a payment method and an identifier associated with a purchaser. A mobile transaction is initiated by placing an on-the-go order for an item with a merchant at a location remote from the purchaser. A secured payment from the payor account is validated by entering the payment password on a purchaser interface, sending the payment password to the remote transaction module, comparing the payment password with the payor account data and validating the payment when the payment password matches the payor account data. The mobile transaction is verified at the remote location by acquiring the purchaser identifier at the remote location, sending the purchaser identifier to the remote transaction module, comparing the purchaser identifier with the payor account data and verifying the transaction when the purchaser identifier matches the payor account data. The mobile transaction is completed when the item is delivered from the merchant to the purchaser.

In one embodiment, a purchase and payment system includes a mobile purchaser module having a purchaser identifier, and a purchaser interface for providing input to the purchase and payment system. A remote transaction module is deployed remotely from the purchaser module and configured to transmit and receive data to register the purchaser, initiate a mobile transaction, validate a transaction payment and confirm completion of the mobile transaction. A merchant module is deployed remote from the purchaser module and the remote transaction module. The merchant module has a merchant or remote user interface for providing input to the purchase and payment system and a sensor for acquiring the purchaser identifier. The purchaser module, the remote transaction module and the merchant module are configured to be in data communication across a data network such as a wireless data network providing communication across the internet.

A method and system in accordance with the present disclosure is particularly well-suited for mobile purchases (such as purchased made while travelling in a vehicle) for providing a secured payment transaction which can be particularly useful for purchasing travel-centric goods and services such as parking fees, toll fees, gasoline charges, and fast-food purchases, as well as well as purchasing events location-based and advertisement-based purchases.

### DESCRIPTION OF THE DRAWINGS

The exemplary embodiments will hereinafter be described in conjunction with the following drawing figures, wherein like numerals denote like elements, and wherein:

FIG. 1 is a functional block diagram of an exemplary mobile e-commerce system for validated payment and verified delivery of goods and/or services;

FIG. 2 is a flow diagram illustrating an exemplary general work flow of the mobile e-commerce method for validated payment and verified delivery of goods and/or services;

FIG. 3 is a flow diagram illustrating an exemplary financial transaction of the work flow shown in FIG. 2;

FIG. 4 is a flow diagram illustrating an exemplary payment validation of the work flow shown in FIG. 2; and

FIG. 5 is a flow diagram illustrating an exemplary delivery of goods/services of the work flow shown in FIG. 2.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, computer, electronic control component, processing logic, and/or processor device, individually or in any combination, including without limitation: application specific integrated circuit (ASIC), an electronic circuit, a processor (shared, dedicated, or group) with suitable memory and peripheral devices that executes one or more computer programs or code embodied in software or firmware on a transitory or non-transitory medium, a combinational logic circuit, and/or other suitable components to provide the described functionality. As used herein, the term vehicle, unless otherwise expressly limited, refers broadly to any device or apparatus for transporting a person or persons whether motorized or not. For example, a vehicle may be a land vehicle (such as a bicycle, automobile, RV, trailer, truck, tractor-trailer, bus, train, etc.) or a marine craft or an aircraft and should not be limited to a passenger vehicle.

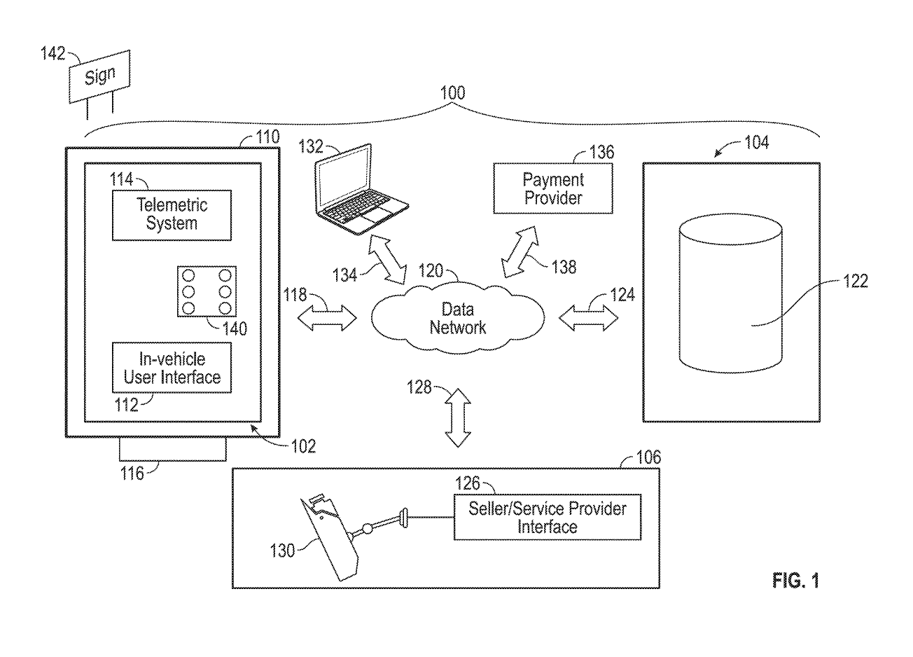

FIG. 1 is a functional block diagram of a mobile purchase and payment system 100 in accordance with various embodiments. Although the figures shown herein depict an example with certain arrangements of elements, additional intervening elements, devices, features, or components may be present in actual embodiments. For example, the mobile purchase and payment system 100 will be further described with reference to a vehicular application in which the purchase and payment is described in the context of an in-vehicle transaction. However, one skilled in the art will understand that the present disclosure is not be limited to transactions of this type, but may more broadly encompass mobile transactions, in general.

As shown, in-vehicle purchase and payment system 100 includes an in-vehicle purchasing module 102, a remote transaction processing module 104 and a merchant module 106. These modules are in data communication across a data network 120 which includes a communication link 118 between the in-vehicle purchasing module 102, a communication link 124 between the remote transaction processing module 104 and a communication link 128 between the merchant module 106. These may be direct communication links or may interconnect though a shared network or through an intermediary which may have shared resources, software, applications and/or information or any other communication architecture which enables data communication therebetween. In this regard, the in-vehicle purchase and payment system 100 may embody a client-server architecture, wherein the purchasing module 102 and the merchant module 106 function as clients through the transaction module 104 which functions as a server. Alternately, in-vehicle purchase and payment system 100, and in one example, the purchasing module 102 and/or the merchant module 106 may be embodied in a hand held computing device such as a smart phone or tablet having a microprocessor and the interface includes an application program executed on the microprocessor to provide the structures and functions described herein and which is deployable or otherwise operably arranged within a vehicle.

The in-vehicle purchasing module 102 is deployed in a vehicle 110 and includes an in-vehicle user interface 112, a telematics system 114 and a vehicle identifier 116. The in-vehicle user interface 112 functions to enable a user/purchaser to interface with the in-vehicle purchase and payment system 100 and may include various input and/or display devices such as input display 140. In one embodiment, the user interface is a programmed processor with one or more peripheral devices which can be seen, heard and/or otherwise perceived by a human user, and the commands and mechanisms the human user may employ to control its operation and input data. In one function, the user interface 112 is operable to enter a payment password. The user interface 112 may include a sensor installed on a steering wheel or touch screen within the vehicle for scanning and entering a finger print or thumb print of the purchaser and obtaining finger print data which may be used as a payment password. The user interface 112 may include a microphone or voice recorder for recording a voice command or voice print of the purchaser and obtaining voice print data which may be used as a payment password. The user interface 112 may include a camera or scanner for imaging the face of the purchaser or a portion thereof (e.g. retina or other biometric information) and obtaining image data which may be used as a payment password. The user interface 112 may include a key pad, keyboard, touchscreen, touch pad or rotary knob for enter a string of characters which may be used as a payment password. The user interface 112 may include a reader or scanner configured to interrogate a key fob and obtain driver identification data which may be use as a payment password. These various input devices may be combined and used as a payment password depending on the protocol and level of security desired for making a secured payment. The user interface 112 may also include a radio device or infotainment system configured to receive an advertising broadcast and present items available for purchase in a human-discernable form for purchase using the in-vehicle purchase and payment system 100.

The on-board telematics system 114 functions to provide data communication with the vehicle 110. The telematics system 114 may include or be coupled with a global positioning system or other devices to provide location information about the vehicle 110. The telematics system 114 may include a service such as the OnStar® service, a wireless communication device which employs high-speed data communication such as 3G, LTE, 4G, LTE Advanced or other mobile communication technologies. The telematics system 114 may also include a display configured to present location-based services based on the location information about the vehicle which are available for purchase by the driver with the in-vehicle purchase and payment system 100. As such, the telematics system 114 may part of an infotainment system integrated within the vehicle 110.

The vehicle identifier 116 includes data associated with the vehicle 110 and/or the in-vehicle purchasing module 102 which provides a unique identifier for the vehicle 110 and/or the purchaser and is used to verify a transaction. The vehicle identifier 116 is easily accessible from outside the vehicle 110. As such, the vehicle license plate may function as a suitable vehicle identifier 116. Other suitable vehicle identifiers may include the vehicle identification number (VIN) or some other code such as a bar code, QR code or radio frequency identification (RFID) tag uniquely associated with a particular vehicle or purchaser which can be readily ascertained by the merchant module 106.

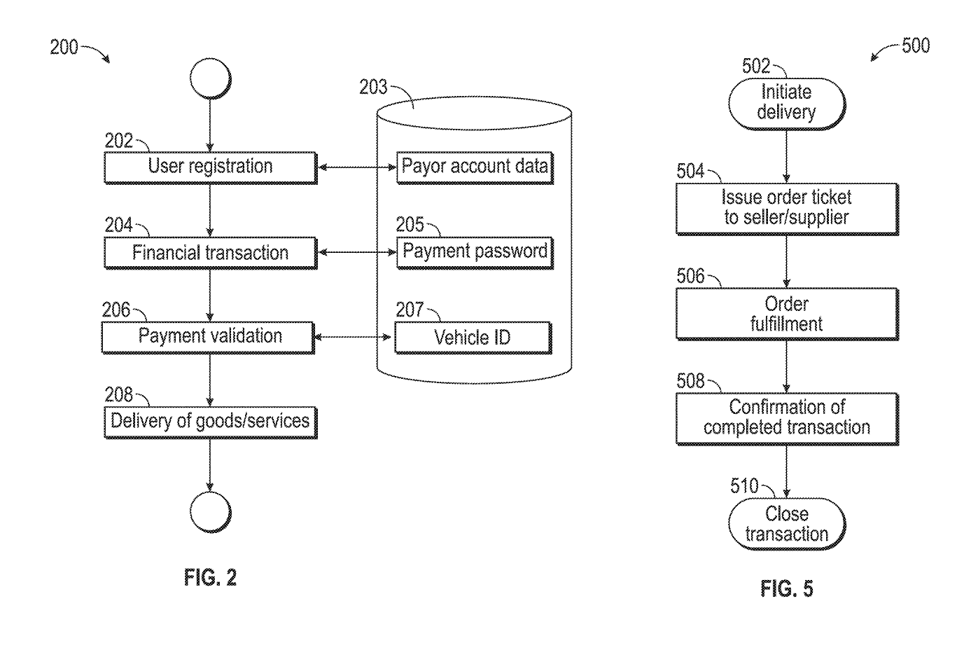

The transaction module 104 is configured to be remote from the vehicle 110 and communicates with the in-vehicle purchasing module 102 and the merchant module 106 to affect purchase and payment transactions. In this regard, the transaction module 104 enables the method shown in the transaction process flow 200 in FIG. 2.

The transaction module 104 is operable to register a payor account as shown in block 202 of FIG. 2. The payor account is a data structure which associates a user ID, a payment password, a payment method and the vehicle identifier 116 with payor account. The payor account data 203 may include identifying data such as name and address as well as purchasing preference data about the user. The payment password may include one or more password data 205 as referenced above in conjunction with the user interface 112. In this regard, the transaction module 104 may be operable to query the user interface 112 and prompt the user to input a payment password as shown in block 204 of FIG. 2. Alternately, with reference to FIG. 1, the transaction module 104 may be accessed from a remote terminal 132 in communication with the data network 120 via a communication link 134 for inputting a payment password, provided the payment password is suitable for re-entry on the user interface 112 in the vehicle 110 as shown in block 204. The remote terminal may be a computer, tablet or other mobile device programmed to interface with the transaction module 104 through the data network 120.

The transaction module 104 associates a vehicle identifier 116 which includes identifying data for the vehicle associated with the payor account. The vehicle identifier may include one or more vehicle data referenced above in conjunction with the vehicle identifier. In this regard, the transaction module 104 may be operable to query the user interface 112 and prompt the user to input the vehicle identifier 116. Alternately, the transaction module 104 may be accessed from a remote terminal 132 in communication with the data network 120 for inputting a vehicle identifier 116, provided the vehicle identifier data is suitable for data capture by the merchant module 106.

A payment method is also associated with the payor account data 203 to enable a payment for the purchased items from a payment provider 136 in communication with the data network 120 via a communication link 138. In this regard, the payment method may be a credit card, debit card or banking account authorized by the transaction module to transfer funds associated with the purchaser to a merchant in response to a transaction request. Alternately, the payment method may be a mobile payment, digital wallet or online money transfer service for making an electronic payment in response to a transaction request. In this regards, the user would associate an existing electronic payment account, such as an account with PayPal, Apple, Amazon or Western Union, as an approved payment method for the payor account on the transaction module. Once registered, the payor account can only be accessed by the user interface 112 if the proper user ID, payment password 205 and vehicle identifier 207 are input, validated and verified by the transaction module 104.

As shown in FIG. 2, the transaction module 104 is also operable to facilitate a financial transaction as shown in block 206, validate payment for the financial transaction as shown in block 208 and coordinate delivery of any goods/services purchased by the financial transaction as shown in block 210. The financial transaction is typically the purchase of goods and/or service or payment of a toll or fee initiated by the user on the user interface 112. The financial transaction may be initiated in response to an advertisement on a road side sign or display 142, or in response to an in-vehicle advertisement over the user interface 112 and/or infotainment system. The financial transaction may also be initiated in response to a location-based service promotion based on the location data acquired from the telematics system 114 and broadcast over the user interface 112 and/or infotainment system. The transaction module 104 is in communication with the purchasing module 102 via the data network 120 and communication links 118, 124 and operable to initiate a financial transaction and request input of the payment password by the user/purchaser. The transaction module 104 is in communication with the payment provider 136 via the data network 120 and communication links 124, 138, and is operable to affect payment for the financial transaction. The transaction module 104 is in communication with the merchant module 106 via the data network 120 and communication links 124, 128, and is operable to coordinate delivery of the goods/services and to complete the financial transaction.

Referring again to FIG. 1, the merchant module 106 is also configured to be remote from the vehicle 110 and associated with a merchant for the goods/services being purchased in the financial transaction 206 of FIG. 2. The merchant module 106 includes an interface 126 for the seller of certain goods or provider of certain services, hereinafter referred to as the seller interface 126. The seller interface 126, similar to the user interface 112, functions to enable a merchant to interface with the in-vehicle purchase and payment system 100 and may include various input devices as well as display devices. The merchant module 106 also includes a device 130 for acquiring vehicle identification data 207 from a vehicle 110 associated with the financial transaction for verification thereof. The device 130 may be any device suitable for acquiring vehicle identification data 207 of the type associated with the vehicle identifier. For example, if the vehicle identifier 116 is a license plate number, then the device 130 may be a camera enabled for image and/or text recognition of the license plate. If an RFID tag is used for the vehicle identifier than the device would be a suitable RFID reader. Likewise, if a symbology code, such as bar or QR coding, is used than the device would be a suitable bar or QR scanner.

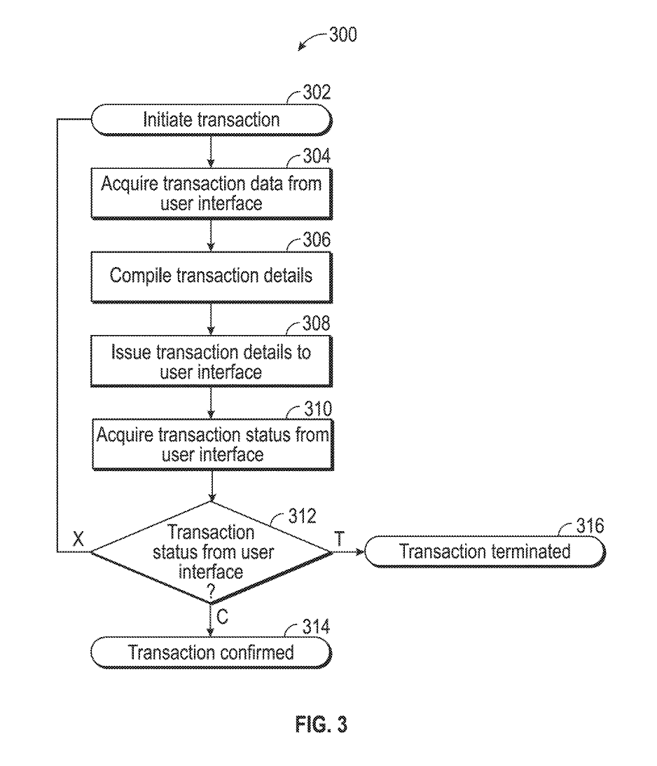

Turning now to FIGS. 3-5, the various process flows to make a secured payment transaction for purchasing vehicle-centric goods and services such as parking fees, toll fees, gasoline charges, and fast-food purchases, as well as well as location-based and advertisement-based purchases are illustrated. Once registered with the in-vehicle purchase and payment system 100, a user/purchaser may perform a financial transaction as shown at process flow 300 in FIG. 3. In one example, a transaction is initiated at block 302 and the user provides transaction input data via the user interface 112, which is transmitted via communication links 118, 124 and data network 120 to the transaction module 104 at block 304. At a minimum the transaction input data should include the merchant and the goods/services to be purchased, but may also include discount coupons, referral information or other transaction related information. Additional input data may include location for transaction and estimated time for pickup as shown at block 306. This additional data input may be provided via the user interface 112 or alternately acquired from the telematics system 114. The transaction module 104 will compile a set of transaction details based on the input data and present these transaction details to the user/purchaser as shown at block 306 and issues the transaction detail back to the user interface 112 at block 308 and requests a transaction status. The user/purchaser may provide the transaction status on the user interface 112 which is acquired by the transaction module 114 as shown at block 310. The transaction status may include: approved (“A”), rejected (“X”) or terminated (“T”). The transaction module 104 acquired and checks the transaction status as block 312. If the transaction status is rejected or terminate, the transaction module check the transaction status again at block and proceed based and checks for transaction confirmation at block 312. If the transaction status is approved shown as “A” at block 312, then the financial transaction is confirmed at block 314. If the transaction status is rejected as shown as “X” at block 312, then the financial transaction may be re-initiated at block 302. If the transaction status is terminated as shown as “T” in block 312, then the financial transaction is terminated at block 316.

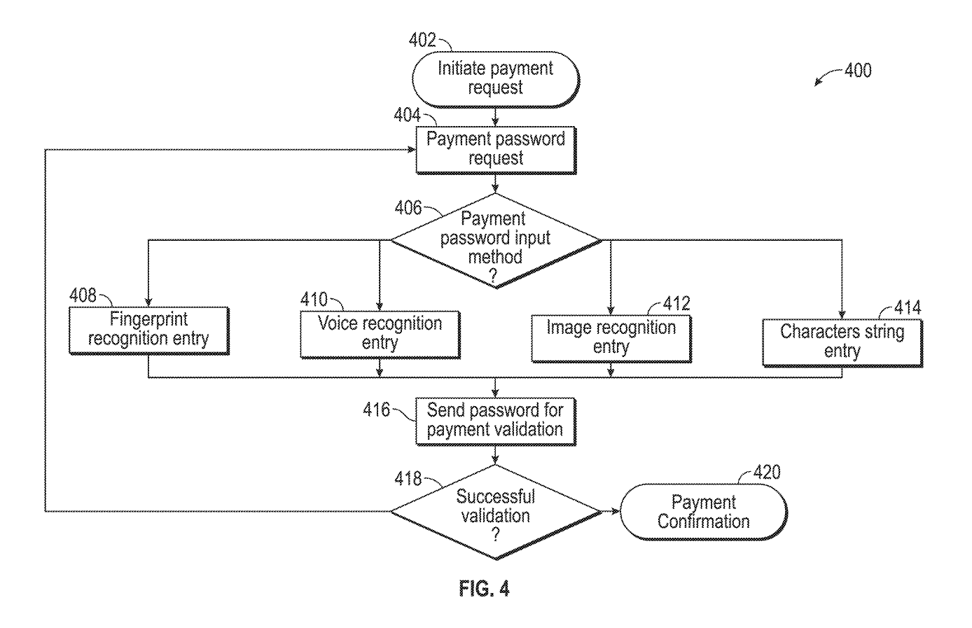

Assuming the financial transaction is confirmed, payment is validated for the financial transaction as shown at validation process flow 400 in FIG. 4. A payment request is initiated from a registered payor account by the transaction module 104 by requesting entry of the payment password 205. For this, the transaction module 104 will query the payor account to determine the appropriate payment password input method as shown at block 406. If the payment password includes fingerprint data, then the transaction module 104 will issue a query for the user/purchaser on the user interface 112 to provide a fingerprint recognition entry as shown at block 408. If the payment password includes voice recognition data, then the transaction module 104 will issue a query for the user/purchaser on the user interface 112 to provide a voice print entry as shown at block 410. If the payment password includes image recognition data, then the transaction module 104 will issue a query for the user/purchaser on the user interface 112 to provide an image recognition entry as shown at block 412. The image recognition data may take various forms so long as it provides unique data to be used for a payment password. For example, the image recognition data may be based on a facial image, an iris or retina scan or other image-acquired biometrics information. If the payment password includes character string data, then the transaction module 104 will issue a query for the user/purchaser on the user interface 112 to provide a character string entry as shown at block 414. The user interface 112 sends the payment password back to the transaction module 104 where it is compared to the payment password data 205 on record for validation as shown at block 416. If the payment password data 205 matches the payment password on record as shown at block 418, then the transaction module 114 validate the payment which is further processed to pay the merchant associated with the financial transaction as shown at block 420. If the payment password is not successfully validated, then the transaction module 104 may re-initiate the payment password request at block 404.

Assuming the payment has been validated, the delivery of goods/services purchased in the financial transaction is shown at delivery process flow 500 in FIG. 5. In one example, the merchant module 106 initiates delivery of the goods/service as shown at block 502. The transaction module 104 issues transaction data in the form of an order ticket or similar data file at block 504 to the seller interface 126 (FIG. 1) which may be used by the merchant to fulfill the order as shown at block 506. The transaction data may include an estimated time of delivery based on the location of the vehicle 110 relative to the merchant, as well as other data such as traffic and/or weather information available from the telematics system 114 or the data network 120. In other words, the transaction module 104 acquires payment validation data and GPS data as input when the payment validation data indicates a valid payment was made. In response, the transaction module 104 issues transaction data to the merchant module 106, which includes an estimated time of delivery. When the user/purchaser arrives at the merchant location, the merchant module 106 queries the vehicle 110 to acquire vehicle identifier data 207 via device 130 and confirm that the vehicle identifier data 207 matches the vehicle identifier 116 associated with the financial transaction to confirm completion of the transaction as shown at block 508. When the transaction is confirmed, the merchant delivers the goods/services to the user/purchaser and the transaction is closed as shown at block 510.

The methods and systems described herein facilitate shopping services and in-vehicle transactions which allows consumers to instantly purchase an item based on information seen and/or heard which in their vehicles. An in-vehicle purchase and payment method and system eliminates the need to exit the vehicle to make a payment and enables advanced payment so there is no need to wait in a line. The methods and systems described herein are well-suited for purchase and payment of certain vehicle-centric goods and services such as toll fees, parking fees, gasoline, location-based and roadside advertisements, and investment purchases as well as wagering and gambling.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A purchase and payment system for initiating and completing a transaction from a mobile location, the system comprising:
a purchaser module in data communication with a data network and having a user interface for providing input to the purchase and payment system;
a purchaser identifier associate with but remote from the purchaser module;
a remote transaction module configured to be deployed remotely from the purchaser module and in data communication with the data network, the remote transaction module configured to transmit and receive data to register a purchaser, initiate a transaction, validate a transaction payment and confirm completion of the transaction; and
a merchant module configured to be deployed remote from the purchaser module and the remote transaction module and in data communication with the data network, the merchant module having a remote user interface for providing input to the purchase and payment system and a sensor for acquiring the purchaser identifier.

2. The purchase and payment system according to claim 1 wherein the user interface is selected from the group comprising a scanner configured to record a finger print, a voice recorder configured to record a voice print, a camera configured to capture a facial image, a keyboard configured to enter an alphanumeric string, and combinations thereof.

3. The purchase and payment system according to claim 1 wherein the purchaser module further comprising a radio device configured to advertise an item for purchase in a human-discernable form.

4. The purchase and payment system according to claim 1 wherein the purchaser module further comprises a telematics system for acquiring positional information thereof

5. The purchase and payment system according to claim 4 wherein the purchaser module further comprises a display configured to present location-based services based on positional information from the telematics system.

6. The purchase and payment system according to claim 1 wherein the purchaser module is configured to be deployed in a vehicle having a vehicle identifier, and wherein the purchaser identifier is the vehicle identifier.

7. The purchase and payment system according to claim 6 wherein the vehicle identifier is a vehicle license plate.

8. The purchase and payment system according to claim 7 wherein the sensor is a camera configured to generate an image of the vehicle license plate.

9. The purchase and payment system according to claim 1 wherein the data network is a wireless data network.

10. A method for making a transaction payment comprising:
registering a payor account on a remote transaction module, the payor account having a user ID, a payment password, and a payment method;
associating a purchaser identifier associated with the payor account, wherein the purchaser identifier is different that the user ID and payment password;
processing a transaction including receiving an order from an user interface for an item with a merchant at a remote location;
validating a payment from the payor account including entering the payment password on the user interface, comparing the payment password with the payor account and validating the payment when the payment password matches the payor account; and
verifying the transaction at the remote location including acquiring a purchaser identification at the remote location, comparing the purchaser identifier associated with the payor account and the purchaser identification and verifying the transaction when the purchaser identification matches the purchaser identifier.

11. The method according to claim 19 wherein entering the payment password comprises at least one of the following: finger print data, voice print data, biometric image data and alphanumeric data.

12. A method for making a transaction payment from a vehicle comprising:
registering a payor account having a user ID, a payment password, a payment method and a vehicle identifier to enable an in-vehicle transaction;
processing a transaction on an in-vehicle interface including receiving an order from the vehicle for an item with a merchant at a location remote from the vehicle;
authorizing a payment from the payor account including receiving the payment password from the in-vehicle interface deployed in the vehicle for validating the payment; and
receiving the vehicle identifier from the merchant at the remote location for verifying the in-vehicle transaction.

13. The method according to claim 12 further comprising sending the payment password to a payment module for payment validation.

14. The method according to claim 12 further comprising initiating the in-vehicle transaction in response to an in-vehicle advertisement.

15. The method according to claim 12 further comprising acquiring location data for the vehicle.

16. The method according to claim 15 further comprising initiating the in-vehicle transaction in response to a location-based service promotion based on the location data.

17. The method according to claim 15 further comprising computing an estimated time of arrival of the vehicle at the merchant based on the location data.

18. The method according to claim 17 further comprising sending the estimate time of arrival to the merchant.

19. The method of according to claim 12 wherein receiving the payment password comprises receiving at least one of the following: finger print data, voice print data, biometric image data and alphanumeric data.

20. The method of according to claim 12 further comprising presenting an order ticket to the merchant at the remote location.
